(19) United States
(12) Patent Application Publication
(10) Pub. No.: US 2025/0139913 A1
(43) Pub. Date: May 1, 2025

(54) SYSTEMS AND METHODS FOR EDGE-DRIVEN OBJECT DETECTION FOR RESOURCE OPTIMIZATION

(71) Applicant: Toyota Motor Engineering & Manufacturing North America, Inc., Plano, TX (US)

(72) Inventors: Daniel Doe, San Jose, CA (US); Dawei Chen, Milpitas, CA (US); Kyungtae Han, Palo Alto, CA (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/825,745

(22) Filed: Sep. 5, 2024

Related U.S. Application Data
(60) Provisional application No. 63/592,958, filed on Oct. 25, 2023.

(51) Int. Cl. G06T 19/00; B60W 30/09; G06V 20/56

(52) U.S. Cl. CPC G06T 19/006; B60W 30/09; G06V 20/56

(57) ABSTRACT

System and method for reducing latency and bandwidth usage include a reality device and one or more processors. The reality device includes a camera to operably capture a frame of a view external to a vehicle. The one or more processors are operable to send the frame to an edge server, receive object detection data from the edge server, wherein the object detection data includes object information in the frame, and instruct the reality device to render a mixed reality environment with the object detection data.

This application claims priority to co-pending provisional U.S. Application No. 63/592,958, filed Oct. 25, 2023, which is incorporated herein by reference in its entirety.

### TECHNICAL FIELD

The present specification generally relates to mixed reality, augmented reality, and virtual reality and, more specifically, to mixed reality, augmented reality, and virtual reality using in networking.

### BACKGROUND

Augmented reality (AR) technologies can be integrated into vehicle applications to enhance user interaction and mobility experiences. Remote AR data processing can release local AR computation usage and leverage cloud resources. Therefore, there is a need for a system and method for mixed reality (MR) applications that employ edge-driven object detection for resource optimization to maintain network performance and cost-effectiveness.

### SUMMARY

In one embodiment, a system for reducing latency and bandwidth usage in reality devices includes a reality device and one or more processors. The reality device includes a camera to operably capture a frame of a view external to a vehicle. The one or more processors are operable to send the frame to an edge server, receive object detection data from the edge server, wherein the object detection data includes object information in the frame, and instruct the reality device to render a mixed reality environment with the object detection data.

In a second embodiment, a server for reducing latency and bandwidth usage in reality devices includes one or more processors operable to receive a frame of a view external to a vehicle from a reality device, generate object detection data, and send the object detection data to the reality device to render a mixed reality environment with the object detection data by the reality device. The reality device includes a camera to operably capture the frame. The object detection data comprises information about objects in the frame.

In a third embodiment, a method for reducing latency and bandwidth usage in reality devices includes sending a frame of a view external to a vehicle to an edge server, receiving object detection data from the edge server, and instructing the reality device to render a mixed reality environment with the object detection data. The frame is captured by a reality device. The object detection data includes object information in the frame.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example system for reducing latency and bandwidth usage in mixed reality (MR) usage of the present disclosure, according to one or more embodiments shown and described herewith;

FIG. 2 schematically depicts example components of reality devices of the present disclosure, according to one or more embodiments shown and described herein;

FIG. 3 schematically depicts example components of edge server of the present disclosure, according to one or more embodiments shown and described herein;

FIG. 4A schematically depicts an example system for performing frame transmission in MR usage of the present disclosure, according to one or more embodiments shown and described herein;

FIG. 4B schematically depicts a flowchart for performing frame transmission in MR usage of the present disclosure, according to one or more embodiments shown and described herein;

FIG. 5 depicts a sequence diagram for performing frame transmission in MR usage of the present disclosure, according to one or more embodiments shown and described herein; and

FIG. 6 depicts a flowchart for performing frame transmission in MR usage of the present disclosure, according to one or more embodiments shown and described herein.

### DETAILED DESCRIPTION

Mixed reality (MR) technology, such as augmented reality (AR) or virtual reality (VR), often relies on a combination of on-device and cloud-based processing for tasks like image classification and object recognition. The development of MR-integrated autonomous vehicles and AR technologies is revolutionizing mobility and user interaction experiences. Among the applications of AR technologies, real-time object detection is a desirable feature for MR applications in MR-integrated autonomous vehicles. These object detection tasks may involve context-sensitive driving, such as understanding the user's expectations when regularly looking at scenery, wildlife, or landmarks, providing real-time navigation assistance, and adjusting object detection based on the user's behavior and interactions with others in the vehicle.

Object detection tasks can be performed either locally on user devices or remotely on servers. Due to limitations in processing power, memory, and energy efficiency, processing MR data locally on reality devices may not always be feasible or desirable. High computational requirements can limit MR functionality, drain vehicle resources, and potentially create unsafe situations. Instead, server-based processing can manage computationally intensive tasks like object recognition, scene understanding, and spatial mapping. This remote processing leverages powerful cloud resources and advanced machine learning algorithms, allowing for real-time analysis and access to continually updated models and data.

Remote XR-based tasks must balance computational requirements and bandwidth usage. Current methods rely on transmitting image frames to remote devices and servers, regardless of the distance between the local devices and the remote servers, which may lead to high bandwidth consumption and latency. These methods do not adapt to data transmission delay due to transmission distances, resulting in delays and lags that degrade the user experience due to resource over-utilization. Further, information and outcomes may be transmitted from the server often integrated into the received frames to generate processed frames via wireless communication, where the transmission data sizes are often undesirable and may cause information latency. Accordingly, there exists a need to reduce latency and bandwidth usage in the MR devices by reducing data transmission distance between the reality devices and the server and minimizing task results data transmitted from the server back to the reality devices.

To address the issues of latency and bandwidth usage, the disclosed system and method perform edge-driven object detection based on edge computing for optimal resource utilization. By utilizing the edge computing for computations to be performed close to the data source and minimizing the computation results sent from the edge server to the reality devices, the disclosed system and method enables fast decision-making, creates a resource-efficient MR experience, and reduces data transmission to improve the system overall performance. The system for reducing latency and bandwidth usage includes a reality device including a camera to operably capture a frame of a view external to a vehicle. The reality devices may send the frame to an edge server, receive object detection data from the edge server. The received object detection data may include object information in the frame but does not include the frames received by the edge server or any integrated frames containing the calculated outcomes and/or information related to the frame. The system may further instruct the reality device to render a mixed reality environment with the object detection data.

Embodiments of systems and methods disclosed herein include a reality device including a camera and a processor. The reality device may be an AR device, such as an AR headset, a VR device, or an MR device. The camera operably images an environment around a vehicle, such as an automatic vehicle, and captures a set of frames. In the embodiments, the computational tasks that require intense computing resources and thus are undesirable for local processing by the MR device are uploaded to and performed by an edge server. The system thus addresses the latency during object detection using the MR interface and enhances the MR experience of the user, making the MR experience more immersive and responsive.

As disclosed throughout the description, edge computing refers to a distributed computing paradigm that brings computation and data storage closer to the sources of data. Edge computing pushes processing and data storage to a network's edge, closer to end-users and devices instead of relying solely on centralized data centers. An edge server refers to any physical hardware and/or servers that enable edge computing located at the network's edge, closer to data sources or end-users. The edge server may handle data processing, storage, and analysis locally, reducing the need to transmit data to central data centers, such as a cloud server. The edge server may include specialized hardware optimized for specific workloads, such as video processing. The edge computing and edge server work together to bring computation and data storage to the point of action, and reduce latency.

Various embodiments of the methods and systems for reducing latency and bandwidth usage in MR applications through edge-driven object detection are described in more detail herein. Whenever possible, the same reference numerals will be used throughout the drawings to refer to the same or like parts.

As used herein, the singular forms “a,” “an” and “the” include plural referents unless the context clearly dictates otherwise. Thus, for example, reference to “a” component includes aspects having two or more such components unless the context clearly indicates otherwise.

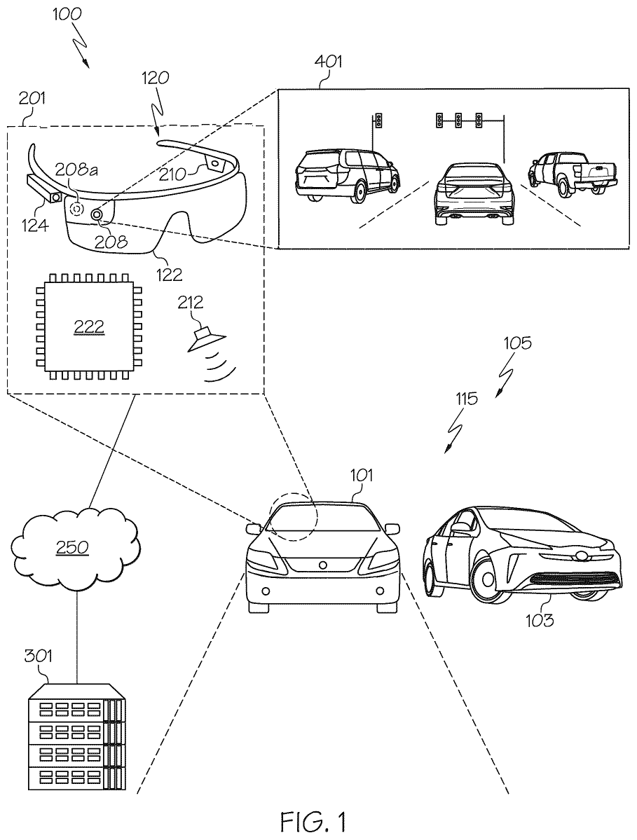

Referring now to Figures, FIG. 1 schematically depicts an example edge-driven object detection system 100. The edge-driven object detection system 100 includes components, devices, and subsystems based on MR-related and data-transmission-based technologies for information deployments during vehicle driving experiences. The MR technologies provide augmented and virtual reality experiences to one or more users (e.g., drivers and/or passengers) of an ego vehicle 101 to enhance situational awareness and entertainment during driving. The data transmission allows a real-time information flow to deliver information to the users in a timely and effective manner. Particularly, the edge-driven object detection system 100 may capture an image or a frame 401 of environment 105 surrounding the ego vehicle 101 and transfer the image or the frame 401 to an edge server 301 for task performance via wireless communication 250. The edge-driven object detection system 100 may receive data transmitted from the edge server 301 and further integrate the received data into the MR function deployments.

The edge-driven object detection system 100 may include one or more reality devices 201. The reality devices 201 are the local devices and components used by a user for the MR experience, such as while driving an autonomous vehicle. In some embodiments, the reality devices 201 may perform any MR-related functions to interact with the user to provide an immersive MR experience, without any assistance of external devices or cloud-based services. In some embodiments, the reality devices 201 may collaborate with external devices and services, such as the wireless communication 250 and the edge server 301, to enhance the MR experience for the user when local devices may be insufficient to perform the desirable tasks or provide desirable information.

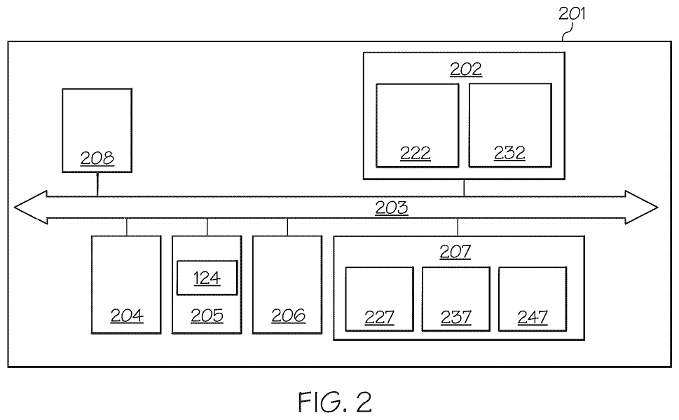

In some embodiments, the reality devices 201 may include, without limitation, a virtual head unit 120, a computation offloading module 222, one or more sensors, such as a vision sensor 208, an eye-tracking sensor 208a, and a head-tracking sensor 210, a rendering device 124, a sound sensor 212, or a combination thereof. The eye-tracking sensor 208a may capture information regarding the user's eyes, such as the user eye movements. The vision sensor 208 may operably capture environmental images or videos in consequence of one or more frames 401 of environment 105 around the user and/or the ego vehicle 101. The reality devices 201 may further include the network interface hardware 206 (e.g., as illustrated in FIG. 2) that can be communicatively coupled to a wireless communication 250 to transmit data to and/or from external computing resources, such as the edge server 301.

In some embodiments, the virtual head unit 120 may include, without limitations, the vision sensor 208, glasses 122, the eye-tracking sensor 208a, the head-tracking sensor 210, and the rendering device 124. The eye-tracking sensor 208a may operably track the user's eye movements, such as, without limitation, positions, angles, or pupil sizes of the one or more eyes of the user. The eye-tracking sensor 208a may enable the edge-driven object detection system 100 to understand where the user is looking for gaze-based interaction with virtual objects, adjust the level of operation of the system to improve performance and reduce computational load, and analyze the user's attention and interest. The head-tracking sensors 210 may track the user's head movement. The head-tracking sensor 210 may allow the edge-driven object detection system 100 to understand the position and orientation of the user's head in physical space. The rendering devices 124, such as one or more projectors, may superimpose images or texts onto the user's eyes or an immersive screen, such as a see-through display or the glasses 122, to render the images or texts into the real-world view of the user.

In some embodiments, the vision sensor 208 may be operable to acquire image and video data, such as one or more frames 401, of the environment 105 surrounding the reality devices 201. The vision sensor 208 may include the eye-tracking sensor 208a operable to acquire images and video data of the user's eyes. The vision sensor 208 may be, without limitation, an RGB camera, a depth camera, an infrared camera, a wide-angle camera, an infrared laser camera, or a stereoscopic camera. The vision sensor 208 may be equipped, without limitation, on a smartphone, a tablet, a computer, a laptop, the virtual head unit 120, or on the ego vehicle 101. In operation, the vision sensor 208 may continuously capture one or more frames 401 of the environment 105 surrounding the reality devices 201 or the ego vehicle 101.

In some embodiments, the edge-driven object detection system 100 may include one or more displays. The display may be equipped, without limitation, on the ego vehicle 101, a touchscreen, a smartphone, a tablet, a computer, a laptop, or the virtual head unit 120. The captured frames or processed frames marked with detected objects with or without related information may be displayed on the displays.

In some embodiments, the vision sensor 208, the eye-tracking sensor 208a, the head-tracking sensor 210, and the rendering device 124 may be included in the ego vehicle 101. For example, the vision sensor 208, the eye-tracking sensor 208a, the head-tracking sensor 210, or the rendering device 124 may be mounted on a windshield, a steering wheel, a dashboard, or a rearview mirror of the ego vehicle 101.

In some embodiments, the edge-driven object detection system 100 may include an interaction device. The interaction device may provide communication between the user and the virtual world. The interaction device may include a tangible object, such as, without limitations, a marker, a physical model, a sensor, a wearable motion-tracking device, or a smartphone.

In some embodiments, the edge-driven object detection system 100 may include a sound sensor 212. The sound sensor 212 may operably determine the volume, pitch, frequency, and/or features of sounds in the ego vehicle 101 or around the virtual head unit 120. The sound sensor 212 may be embedded in the virtual head unit 120 or inside the ego vehicle 101 to detect and process the sound waves that are produced when the user or a passenger speaks in the ego vehicle 101. The edge-driven object detection system 100 may include a speech processor to convert the sound waves into human language and further recognize the meaning within, such as user commands.

In some embodiments, the computation offloading module 222 may include one or more processors communicately coupled to other reality devices. The computation offloading module 222 may receive data generated by one or more other reality devices 201, such as the image or video data generated by the vision sensor 208 and the eye-tracking sensor 208a, the sound data generated by the sound sensor 212, and the motion data generated by the head-tracking sensor 210. The computation offloading module 222 may further inquire and receive information on external hardware and devices, such as the wireless communication 250 and the edge server 301. The computation offloading module 222 may determine whether to transmit the real-time frames 401 to the edge server 301.

The edge-driven object detection system 100 may include one or more processors (e.g., as illustrated in FIG. 2). The processors may be included, without limitation, in a controller (such as a computer, a laptop, a tablet, or a smartphone), the virtual head unit 120, a server, or a third-party electronic device.

The edge-driven object detection system 100 may include the ego vehicles 101. In embodiments, each of the ego vehicles 101 may be an automobile or any other passenger or non-passenger vehicle such as, for example, a terrestrial, aquatic, and/or airborne vehicle. Each of the ego vehicles 101 may be an autonomous vehicle that navigates its environment with limited human input or without human input. Each of the ego vehicle 101 may drive on a road 115, where one or more non-ego vehicles 103 may share the road 115 with the ego vehicle 101. Each of the vehicles 101 and 103 may include actuators for driving the vehicle, such as a motor, an engine, or any other powertrain. The vehicles 101 and 103 may move or appear on various surfaces, such as, without limitation, roads, highways, streets, expressways, bridges, tunnels, parking lots, garages, off-road trails, railroads, or any surfaces where the vehicles may operate.

In embodiments, the vision sensors 208 may continuously capture frames of environment 105 surrounding the user and the ego vehicle 101, such as a non-ego vehicles 103 near the ego vehicle 101, objects in the environment 105 surrounding the ego vehicle, such as buildings, traffic lights, places of interests, contextual information, such as weather information, a type of the road on which the ego vehicle 101 is driving, a surface condition of the road 115 on which the ego vehicle 101 is driving, and a degree of traffic on the road 115 on which the ego vehicle 101 is driving. The environmental data may include buildings and constructions near the road 115, weather conditions (e.g., sunny, rain, snow, or fog), road conditions (e.g., dry, wet, or icy road surfaces), traffic conditions, road infrastructure, obstacles (e.g., non-ego vehicles 103 or pedestrians), lighting conditions, geographical features of the road 115, and other environmental conditions related to driving on the road 115.

In embodiments, the reality devices 201 and/or the ego vehicle 101 may send a request for task performance and the frame 401 or a cropped frame to the one or more edge servers 301. The reality devices 201 and/or the ego vehicle 101 may include a network interface hardware 206 and communicate with the edge server 301 via wireless communications 250. The reality devices 201 and/or ego vehicle 101 may transmit, without limitation, the frame 401 or the cropped frame, environmental data, sensory data, real-time driver reaction time, and user driving statistics associated with the user. In some embodiments, the ego vehicle 101 may communicate with the edge server 301 using a smartphone, a computer, a tablet, or a digital device that requires data processing.

In embodiments, the edge server 301 may be any networked computing device strategically positioned at the periphery of a centralized network, providing localized data processing and storage to reduce latency and enhance real-time interaction capabilities. For example, the edge server 301 may include, without limitation, one or more of cloud servers, smartphones, tablets, telematics servers, fleet management servers, connected car platforms, application servers, Internet of Things (IoTs) servers, or any server with the capability to transmit data with the reality devices 201. The edge server 301 may work with the reality device 201 and/or the ego vehicle to enable efficient offloading of computationally intensive tasks, such as video and image processing. The edge server 301 may include high-performance central processing units (CPUs), graphic processing units (GPUs), memory storage, and specialized AI accelerators, allowing it to perform rapid analysis, rendering, and decision-making processes. In interaction with the ego vehicle 101 and/or the reality devices 201, the edge server 301 may receive raw data streams, process these streams to extract relevant information, and transmit processed data or actionable insights back to the connected device. Additionally, the edge server 301 may manage other tasks, including data filtering, compression, and local storage, offloading the ego vehicle 101 or the reality devices 201 and optimizing overall system performance. The edge server 301 may include server network interface hardware 306 and communicate with the reality devices 201, the ego vehicles 101, and other servers via wireless communications 250. The edge server 301 may include an object detection module 322 operable to analyze uploaded images and video frames to identify any objects of interest within and generate object detection data to send back to the reality devices 201 and/or the ego vehicle 101.

The wireless communication 250 may connect various components, the reality devices 201, the ego vehicle 101, and the edge server 301 of the edge-driven object detection system 100, and allow signal transmission between the various components, the reality devices 201, the ego vehicles, and/or the edge server 301 of the edge-driven object detection system 100. In one embodiment, the wireless communications 250 may include one or more computer networks (e.g., a personal area network, a local area network, or a wide area network), cellular networks, satellite networks, a global positioning system, and combinations thereof. Accordingly, the reality devices 201, the ego vehicles 101, and the edge servers 301 can be communicatively coupled to the wireless communications 250 via a wide area network, a local area network, a personal area network, a cellular network, or a satellite network, etc. Suitable local area networks may include wired Ethernet and/or wireless technologies such as Wi-Fi. Suitable personal area networks may include wireless technologies such as IrDA, Bluetooth®, Wireless USB, Z-Wave, ZigBee, and/or other near-field communication protocols. Suitable cellular networks include, but are not limited to, technologies such as LTE, WiMAX, UMTS, CDMA, and GSM.

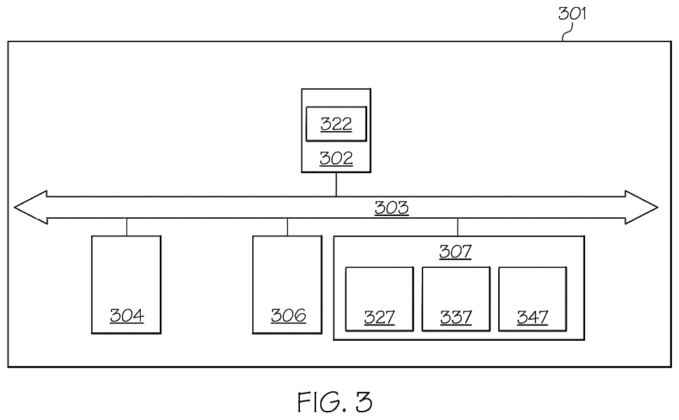

FIGS. 2 and 3 schematically depict example components of the edge-driven object detection system 100. The edge-driven object detection system 100 may include the one or more reality devices 201, the ego vehicle 101, and/or the edge server 301. While FIG. 2 depicts one reality device 201, more than one reality devices 201 may be included in the edge-driven object detection system 100.

Referring to FIG. 2, the reality device 201 may include one or more processors 204. Each of the one or more processors 204 may be any device capable of executing machine-readable and executable instructions. The instructions may be in the form of a machine-readable instruction set stored in data storage component 207 and/or the memory component 202. Accordingly, each of the one or more processors 204 may be a controller, an integrated circuit, a microchip, a computer, or any other computing device. The one or more processors 204 are coupled to a communication path 203 that provides signal interconnectivity between various modules of the system. Accordingly, the communication path 203 may communicatively couple any number of processors 204 with one another, and allow the modules coupled to the communication path 203 to operate in a distributed computing environment. Specifically, each of the modules may operate as a node that may send and/or receive data. As used herein, the term “communicatively coupled” means that coupled components are capable of exchanging data signals with one another such as, for example, electrical signals via a conductive medium, electromagnetic signals via air, optical signals via optical waveguides, and the like.

Accordingly, the communication path 203 may be formed from any medium that is capable of transmitting a signal such as, for example, conductive wires, conductive traces, optical waveguides, or the like. In some embodiments, the communication path 203 may facilitate the transmission of wireless signals, such as WiFi, Bluetooth®, Near Field Communication (NFC), and the like. Moreover, the communication path 203 may be formed from a combination of mediums capable of transmitting signals. In one embodiment, the communication path 203 comprises a combination of conductive traces, conductive wires, connectors, and buses that cooperate to permit the transmission of electrical data signals to components such as processors, memories, sensors, input devices, output devices, and communication devices. Accordingly, the communication path 203 may comprise a vehicle bus, such as for example a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal wave, triangular wave, square-wave, vibration, and the like, capable of traveling through a medium.

The one or more memory components 202 may be coupled to the communication path 203. The one or more memory components 202 may comprise RAM, ROM, flash memories, hard drives, or any device capable of storing machine-readable and executable instructions such that the machine-readable and executable instructions can be accessed by the one or more processors 204. The machine-readable and executable instructions may comprise one or more logic or algorithms written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine-readable and executable instructions and stored on the one or more memory components 202. Alternatively, the machine-readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The one or more processor 204 along with the one or more memory components 202 may operate as a controller or an electronic control unit (ECU) for the reality devices 201 and/or the ego vehicle 101.

The one or more memory components 202 may include the computation offloading module 222 and a user command module 232. The data storage component 207 stores historical eye/head tracking data 237, historical frame/object data 227, and historical user interaction data 247. The historical user interaction data 247 may include, without limitations, historical user driving data, historical user attention data, historical user voice command data, and historical user driving data.

The reality devices 201 may include the input/output hardware 205, such as, without limitation, a monitor, keyboard, mouse, printer, camera, microphone, speaker, and/or other device for receiving, sending, and/or presenting data. The input/output hardware 205 may include the rendering device 124. The rendering devices 124 is coupled to the communication path 203 and communicatively coupled to the one or more processors 204. The rendering device 124 may include, without limitations, a projector or a display. In some embodiments, the rendering device 124 may display digital content directly onto physical surfaces, such as the glass 122. For example, the rendering device may overlay navigation instructions onto the glass 122 or the road 115 while driving or display additional information regarding objects in the environment 105. In some embodiments, the rendering device 124 may project images directly onto the user's retina to create a blend of virtual and real-world visuals.

The reality device 201 may include network interface hardware 206 for communicatively coupling the reality device 201 to the edge server 301. The network interface hardware 206 can be communicatively coupled to the communication path 203 and can be any device capable of transmitting and/or receiving data via a network. Accordingly, the network interface hardware 206 can include a communication transceiver for sending and/or receiving any wired or wireless communication. For example, the network interface hardware 206 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 206 includes hardware configured to operate in accordance with the Bluetooth® wireless communication protocol. The network interface hardware 206 of the reality devices 201 and/or the ego vehicle 101 may transmit its data to the edge server 301 via the wireless communication 250. For example, the network interface hardware 206 of the reality devices 201 and/or the ego vehicle 101 may transmit the frame 401 and other task related data to the edge server 301, and receive processed information, task performance results, and any relevant data, such as, without limitation, vehicle data, image and video data, object detection data, and the like from the edge server 301.

In some embodiments, the vision sensor 208 is coupled to the communication path 203 and communicatively coupled to the processor 204. The reality device 201 and/or the ego vehicle 101 may include one or more vision sensors 208. The vision sensors 208 may be used for capturing images or videos of the environment 105 around the user and/or the ego vehicles 101. In some embodiments, the one or more vision sensors 208 may include one or more imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LIDAR sensors, radar sensors, sonar sensors, or other types of sensors for gathering data that could be integrated into or supplement the data collection described herein. Ranging sensors like radar may be used to obtain rough depth and speed information for the view of the reality devices 201 and/or the ego vehicle 101. The one or more vision sensors 208 may include a forward-facing camera installed in the reality devices 201 and/or the ego vehicle 101. The one or more vision sensors 208 may be any device having an array of sensing devices capable of detecting radiation in an ultraviolet wavelength band, a visible light wavelength band, or an infrared wavelength band. The one or more vision sensors 208 may have any resolution. In some embodiments, one or more optical components, such as a mirror, fish-eye lens, or any other type of lens may be optically coupled to the one or more vision sensors 208. In embodiments described herein, the one or more vision sensors 208 may provide image data to the one or more processors 204 or another component communicatively coupled to the communication path 203. In some embodiments, the one or more vision sensors 208 may also provide navigation support. That is, data captured by the one or more vision sensors 208 may be used to autonomously or semi-autonomously navigate a vehicle.

Referring to FIG. 3, the edge server 301 includes one or more processors 304, one or more memory components 302, data storage component 307, server network interface hardware 306, and a local interface 303. The one or more processors 304 may be a controller, an integrated circuit, a microchip, a computer, or any other computing device. The one or more memory components 302 may comprise RAM, ROM, flash memories, hard drives, or any device capable of storing machine-readable and executable instructions such that the machine-readable and executable instructions can be accessed by the one or more processors 304. The one or more memory components 302 may include an object detection module 322. The data storage component 307 may store historical object detection data 327, historical user preference data 337, and object information data 347.

In some embodiments, the object detection module 322 may, after receiving an object detection task request and the frame 401 or the cropped frame from the reality devices 201 or the ego vehicle 101, normalize, resize, and adjust the received selected frames, use one or more object detection models, such as You Only Look Once (YOLO), Single Shot Multbox Detector (SSD), Region-based Convolutional Neural Networks (R-CNN) to generated model outputs, such as, without limitation, bounding boxes (e.g., coordinates of retangles around detected objects), class labels (e.g., type of the object), and confidence scores for each detected object. In some embodiments, the object detection module 322 may further conduct non-maximum suppression to eliminate redundant overlapping boxes and apply a confidence score threshold to filter out low-confidence detections. The generated detection data, such as [{“Boxes”: [coordinate point 1, coordinate point 2, coordinate point 3, coordinate point 4], “Confidence”: [a value between 0 and 1], “Classes”: “object type”}], for each detected object, may be sent to the reality devices 201. The object detection and detection data transmission may consider other factors, such as the user's preference and past object detection.

Referring back to FIGS. 2 and 3, each of the reality device modules and the server modules, such as the computation offloading module 222, the user command module 232, and the object detection module 322, may include one or more machine learning algorithms. The reality device modules and the server modules may be trained and provided with machine-learning capabilities via a neural network as described herein. By way of example, and not as a limitation, the neural network may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, logistic (Sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error. In ML applications, new inputs may be provided (such as the generated one or more outputs) to the ANN model as training data to continue to improve accuracy and minimize error of the ANN model. The one or more ANN models may utilize one-to-one, one-to-many, many-to-one, and/or many-to-many (e.g., sequence-to-sequence) sequence modeling. The one or more ANN models may employ a combination of artificial intelligence techniques, such as, but not limited to, Deep Reinforcement Learning (DRL), Random Forest Classifiers, Feature extraction from audio, images, clustering algorithms, or combinations thereof. In some embodiments, a convolutional neural network (CNN) may be utilized. For example, a convolutional neural network (CNN) may be used as an ANN that, in the field of machine learning, for example, is a class of deep, feed-forward ANNs applied for audio analysis of the recordings. CNNs may be shift or space-invariant and utilize shared-weight architecture and translation. Further, each of the various modules may include a generative artificial intelligence algorithm. The generative artificial intelligence algorithm may include a general adversarial network (GAN) that has two networks, a generator model and a discriminator model. The generative artificial intelligence algorithm may also be based on variation autoencoder (VAE) or transformer-based models.

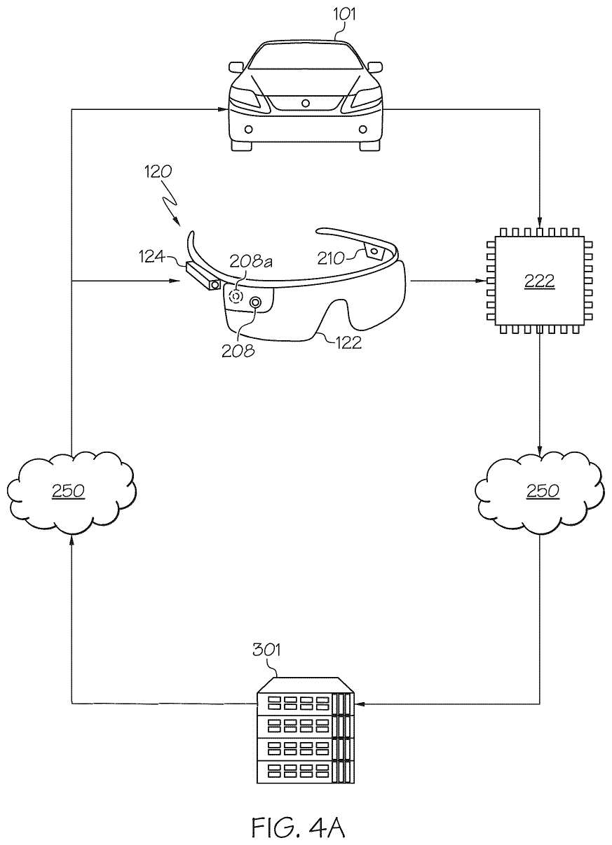

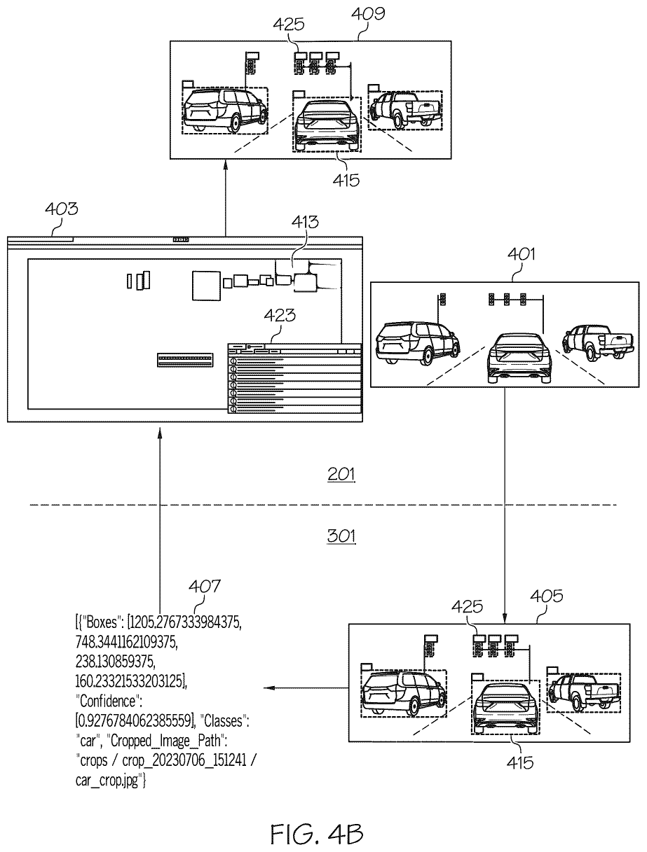

Referring to FIGS. 4A and 4B, the edge-driven object detection system 100 for reducing latency and bandwidth usage is depicted. The edge-driven object detection system 100 may include one or more reality devices 201, including, without limitations, the vision sensor 208 operably capturing a set of consequent frames 401 of views external to the ego vehicle 101. In some embodiments, the computation offloading module 222 may crop the frames 401 to generate one or more cropped frames based on the eye-tracking data and the head-tracking data. The edge-driven object detection system 100 may transmit the frame 401 or the cropped frame to the edge server 301 for performing a task on behalf of the ego vehicle 101.

In some embodiments, in operation, the user may wear the one or more reality devices 201, such as the virtual head unit 120 while using or driving the ego vehicle 101. The vision sensor 208 on the virtual head unit 120 or the ego vehicle 101 may continuously capture images and/or image frames 401 of the environment 105 around the user and/or the ego vehicle 101. The computation offloading module 222 may determine whether to transfer any captured frames 401 to the edge server 301 for image processing tasks, such as object detection, considering the local computing resources and efficiency, and the remote devices and network resources and efficiency. In some embodiments, the computation offloading module 222 may crop the frame 401 to generate the reduced-size frame, and further send the reduced-size frame to the edge server 301 for task performance, such as object detection.

In embodiments, the reality devices 201 and/or the ego vehicle 101 may transmit the frame 401 and object detection task request to the edge server 301 through the wireless communications 250. The edge server 301 may feed the object detection module 322 with the task requirement in the objection detection task request and the frame 401. The object detection module 322 may perform the object detection using one or more object detection models, such as, without limitation, You Only Look Once (YOLO), Single Shot Multbox Detector (SSD), Region-based Convolutional Neural Networks (R-CNN) to detect the objects within the frame 401. In some embodiments, the object detection module 322 may personalize the object detection based on the request information, such as the user's preference, and past object detection, such as the historical object detection data 327, and historical user preference data 337. In some embodiments, the object detection module 322 may further conduct non-maximum suppression to eliminate redundant overlapping boxes and apply a confidence score threshold to filter out low-confidence detections. The object detection module 322 may generate object outputs 405, including various object detection data 407 regarding the frame 401. The object detection data 407, such as, without limitation, box cords 415 (e.g., coordinates of polygons around detected objects in the frame 401) and object information 425, such as class labels (e.g., type of the object), confidence scores (a value between 0 and 1) for each detected object, and cropped image path for each detected object. For example, an object output may include detection data associated with an identified object, such as [{“Boxes”: [coordinate point 1, coordinate point 2, coordinate point 3, coordinate point 4], “Confidence”: [a value between 0 and 1], “Classes”: “object type”}, “Cropped Image Path”: “crops/crop value/crop images”}]. In some embodiments, some of the object detection data 407 can be integrated into the frame 401, such as the box cords 415 and the object information 425.

In some embodiments, a size of the object detection data 407 is smaller than a size of the frame 401. Each box cord 415 may include coordinates of three or more vertices of the corresponding detected object. For example, as illustrated in FIG. 4B, the box coordinates of a non-ego vehicle 103 includes four vertices: [1205.276733984375, 748,344162109375, 238.130859375, 160.23321533203125]. The detected object has a class of “car.” The confidence value of 0.9276784062385559 suggests a high confidence of the detected object as a car at the corresponding box cord. The edge server 301 may further crop the frame 401 to generate a cropped image of the detected object. For example, as illustrated in FIG. 4B, the detected object of the car is associated with a cropped image named “car_crop.jpg.”

In some embodiments, upon object detection, the edge server 301 may further retrieve the object information 425 related to the detected objects from the object information data 347, other databases, or the Internet. The retrieved object information 425 may be included in the object outputs 405 to be sent to the reality devices 201 and/or the ego vehicle 101. For example, in one embodiment, the edge server 301 may recognize the object as a building that may be of interest to the user based on the user reference data. The edge server 301 may then retrieve relevant data of the building to be included in the object outputs associated with the building. In another embodiment, the edge server 301 may recognize the object as a vehicle with a plate number. The edge server 301 may search the plate number from a vehicle database and retrieve public information regarding the driver of the vehicle, such as, whether the driver has any traffic violations, and further to determine whether to include a warning in the object output associated with the vehicle.

In some embodiments, after the edge server 301 performs the requested object detection tasks, with optional detected objects information search and retrieval, the edge server 301 may select generated object detection data 407 to send to the one or more reality devices 201. The selected object detection data 407 may include the bounding boxes, the class labels, the confidence scores, and the retrieved object information associated with the detected objects in the corresponding received frame 401. The selected object detection data may exclude the received frame 401, whose file sizes are usually high in volume. The edge server 301 may then send the object detection data to the reality devices 201 and/or the ego vehicle 101, without sending the frame 401 to the reality devices 201, via the wireless communication 250.

Still referring to FIGS. 4A and 4B, in some embodiments, after receiving the object detection data, the reality devices 201 may generate a simulated-3D view 403 of the object detection data. For example, the reality devices 201 may allocate one or more boundary boxes 413 representing each detected objects based on the coordinates of the detected objects in a 3D environment. The reality devices 201 may include the corresponding class label and confidence score in each boundary box 413. The edge-driven object detection system 100 may monitor the creation of each boundary box 413 and display the creation in a log 423. The reality devices 201 may then superimpose the object detection data onto a real-world view 409 of the user. The object information 425 of each detected object may be rendered in association with the corresponding box cord 415 as an annotation. For example, the rendering device 124 may render the box cords 415 at a truck as a detected object and the retrieved object information 425 (e.g., “truck”) of the truck onto the glasses 122 to blend the information into the user's real-world view 409 in real time.

In some embodiments, after receiving the object detection data, the ego vehicle 101 may be autonomously driven based on the object detection data. The edge-driven object detection system 100 may create a real-time map of the environment 105 and implement a path planning algorithm to determine a desirable route or vehicle operation. The edge-driven object detection system 100 may further control the steering, throttle, and braking system of the ego vehicle 101 and monitor the ego vehicle 101

Referring back to FIGS. 1-4B, in embodiments, the object detection module 322 may include one or more neural networks to train one or more AI algorithms to determine the objects in the frame 401. The neural networks may include an encoder or/and a decoder conjunct with a layer normalization operation or/and an activation function operation. The encoded input data may be normalized and weighted through the activation function before being fed to the hidden layers. The hidden layers may generate a representation of the input data at a bottleneck layer. After delivering neural-network processed data to the final layer of the neural network, a global layer normalization may be conducted to normalize the output, such as predicted driver reaction time. The outputs may be normalized and converted using an activation function for training and verification purposes, as described in detail further below. The activation function may be linear or nonlinear. The activation function may be, without limitation, a Sigmoid function, a Softmax function, a hyperbolic tangent function (Tanh), or a rectified linear unit (ReLU). The neural networks may feed the encoder with historical object detection data 327, historical user preference data 337, and object information data 347. The one or more neural networks may use regression techniques as described herein.

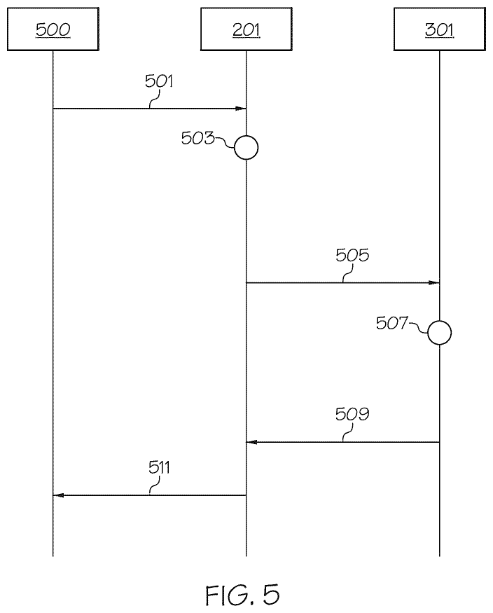

Referring to FIG. 5, a sequence diagram for performing cropping frame transmission in MR usage is depicted. At block 501, a user 500 may wear the reality devices 201, such as the virtual head unit 120, while driving the ego vehicle 101. At block 503, the reality devices 201 may capture eye movements, head movements, and voice commands of the user. At block 505, the reality devices 201 transmit the videos and frames to the edge server 301 for resource optimization and transmitting live video feeds and user interaction data. At block 507, the edge server 301 may perform object detection on the received frame. At block 509, the edge server 301 may send object detection data (e.g., bounding box info) back to the reality devices 201, excluding any large data files, such as the received frame. At block 511, the reality devices 201 may render an MR environment with real-time object detection to the user 500. For example, the reality devices, upon receiving the results from the edge server 301, may generate the mixed reality environment based on the received object detection data and integrate the mixed reality environment into the MR view of the user. In embodiments, the reality devices 201 and the edge server 301 may perform continuous data exchange during user interaction. While FIG. 5 depicts performing object detection tasks, other tasks may be requested by the ego vehicle 101 and/or the reality devices 201, and performed by the edge server 301.

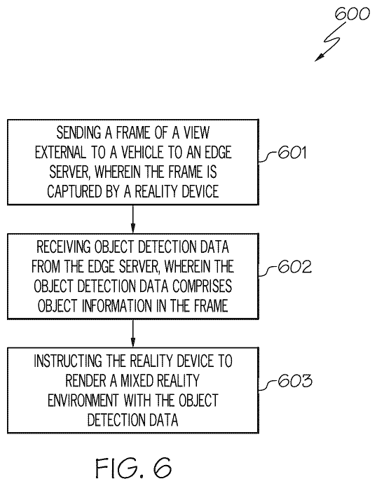

Referring to FIG. 6, a flowchart for illustrative steps for the method 600 for reducing latency and bandwidth usage of the present disclosure is depicted. At block 601, the present method 600 may include sending a frame (such as the frame 401 in FIGS. 1 and 4B) of a view external to a vehicle (such as the ego vehicle 101 in FIGS. 1 and 4A) to an edge server (such as the edge server 301 in FIGS. 1 and 4A). The frame 401 may be captured by a reality device 201 (e.g., in FIGS. 1-2 and 4A). At block 602, the present method 600 may include receiving object detection data 407 (e.g., in FIG. 4B) from the edge server 301. The object detection data 407 may include object information in the frame 401. At block 603, the present method 600 may include instructing the reality device 201 to render a mixed reality environment 403 (e.g., in FIG. 4B) with the object detection data 407.

In some embodiments, a size of the object detection data 407 may be smaller than a size of the frame 401. The edge server 301 may exclude the received frame 401 or any processed frame based on the received frame 401 from the object detection data 407 to send back to the reality device 201. The object detection data 407 may include box cords of detected objects in the frame 401, confidence of each corresponding box cord 415 (e.g., in FIG. 4B), object information 425 (e.g., in FIG. 4B) of each detected object, and a cropped image path (e.g., in FIG. 4B). Each box cord 415 may include coordinates of three or more vertices of the corresponding detected object. The confidence may be a value between 0 and 1, with a higher value represents the higher probably of correctness and/or accuracy. The object information 425 may include a class of the detected object, such as vehicle, building, and the like. The object information 425 of each detected object is associated with the corresponding box cord 415 as an annotation attached to the box cord 415.

In some embodiments, the present method 600 may further include superimposing the object detection data 407 onto a real-world view 409. The present method 600 may further include autonomously driving the ego vehicle 101 based on the object detection data 407.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for reducing latency and bandwidth usage in reality devices comprising:
a reality device comprising a camera to operably capture a frame of a view external to a vehicle; and
one or more processors operable to:
send the frame to an edge server;
receive object detection data from the edge server, wherein the object detection data comprises object information in the frame; and
instruct the reality device to render a mixed reality environment with the object detection data.

2. The system of claim 1, wherein a size of the object detection data is smaller than a size of the frame.

3. The system of claim 1, wherein the object detection data comprises box cords of detected objects in the frame, confidence of each corresponding box cord, and object information of each detected object.

4. The system of claim 3, wherein each box cord comprises coordinates of three or more vertices of the corresponding detected object.

5. The system of claim 3, wherein the confidence is between 0 and 1.

6. The system of claim 3, wherein the object detection data further comprise a cropped image path.

7. The system of claim 3, wherein the object information comprises a class of the detected object.

8. The system of claim 3, wherein the object information of each detected object is associated with the corresponding box cord as an annotation.

9. The system of claim 1, wherein the one or more processors are further operable to superimpose the object detection data onto a real-world view.

10. The system of claim 9, wherein the object detection data are superimposed onto a vision of a user or a current frame.

11. The system of claim 1, wherein the one or more processors are further operable to autonomously drive the vehicle based on the object detection data.

12. A server for reducing latency and bandwidth usage in reality devices comprising:
one or more processors operable to:
receive a frame of a view external to a vehicle from a reality device comprising a camera to operably capture the frame;
generate object detection data, wherein the object detection data comprises information about objects in the frame; and
send the object detection data to the reality device to render a mixed reality environment with the object detection data by the reality device.

13. The server of claim 12, wherein the server sends the object detection data without sending the frame to the reality device.

14. A method for reducing latency and bandwidth usage in reality devices comprising:
sending a frame of a view external to a vehicle to an edge server, wherein the frame is captured by a reality device;
receiving object detection data from the edge server, wherein the object detection data comprises object information in the frame; and
instructing the reality device to render a mixed reality environment with the object detection data.

15. The method of claim 14, wherein a size of the object detection data is smaller than a size of the frame.

16. The method of claim 14, wherein the object detection data comprises box cords of detected objects in the frame, confidence of each corresponding box cord, object information of each detected object, and a cropped image path.

17. The method of claim 16, wherein:
each box cord comprises coordinates of three or more vertices of the corresponding detected object; and
the confidence is between 0 and 1.

18. The method of claim 16, wherein:
the object information comprises a class of the detected object; and
the object information of each detected object is associated with the corresponding box cord as an annotation.

19. The method of claim 14, wherein the method further comprises superimposing the object detection data onto a real-world view.

20. The method of claim 14, wherein the method further comprises autonomously driving the vehicle based on the object detection data.
